(19) United States
(12) Patent Application Publication
(10) Pub. No.: US 2003/0145091 A1
(43) Pub. Date: Jul. 31, 2003

(54) Access terminal profile in a data cellular network

(75) Inventors: Xiaohong Peng, Richardson, TX (US); Sree Lakshmi Dhanekula, Plano, TX (US); Ahmed El-Arabawy, Plano, TX (US); Christina Kim, Coppell, TX (US)

Correspondence Address: Holly L. Rudnick, Jenkens & Gilchrist, P.C., 3200 Fountain Place, 1445 Ross Avenue, Dallas, TX, 75202-2799, US

(73) Assignee: Telefonaktiebolaget L M Ericsson, Stockholm (SE)

(21) Appl. No.: 10/059,522

(22) Filed: Jan. 28, 2002

(51) Int. Cl. G06F 15/16

(52) U.S. Cl. 709/229; 709/203

(57) ABSTRACT

An Access Terminal (AT) profile for identifying data services subscribed to by a data-only (DO) AT or hybrid AT in data mode is stored within a data cellular network, such as a 1xEV DO cellular network. In one embodiment, the subscriber AT profile is stored in a home Access, Authentication and Accounting (AAA) server associated with a home Access Network (AN) of the AT. The subscriber AT profile stored in the home AAA server can be downloaded to the home AN at successful authentication. The current session record in the AN is expanded to include the subscriber profile. In another embodiment, when roaming in a visitor AN, the subscriber AT profile can be downloaded from the home AAA server to the visitor AAA server, prior to downloading the subscriber AT profile to the visiting AN.

### BACKGROUND OF THE INVENTION

1. Field of the Invention

The present invention relates generally to data cellular networks, and specifically to feature control in data cellular networks.

2. Description of Related Art

High Data Rate (HDR) is a technology originally developed for dedicated packet data applications to meet the increasing demand for wireless Internet Protocol (IP) connectivity with high spectral efficiency. Voice transmissions require low data rates, but maintain stringent delay and jitter requirements. Packet data transmissions, on the other hand, typically require bursty high data rates, with less stringent delay and jitter requirements. The HDR principle is to separate high-speed data completely from the voice network, so that the packet data requirements can be fulfilled optimally and independently.

In May 2000, the CDMA Development Group (CDG) accepted HDR as the 1xEvaluation Phase One: Data Only (1xEV DO or 1xEV Phase 1), with minor requirements for improvements. Within the 1xEV DO cellular network, data-only (DO) mobile terminals, hereinafter referred to as Access Terminals (AT), utilize data services by initiating data sessions with data-only base stations, hereinafter referred to as Access Networks (AN). The AN's transmit and receive data packets to and from AT's over the air interface, and support packet data speeds above 144 kbps. It should be understood that the term AT as used herein refers to both DO terminals that utilize only data services and hybrid mobile terminals that are capable of utilizing both data services and voice services, but are currently operating in data mode.

To initiate a data session, an AT requests from a serving AN a Unicast Access Terminal Identifier (UATI) that uniquely identifies the AT within the serving AN. Upon receipt of the UATI, the AT engages in a session protocol negotiation and authentication process with the serving AN for the data session. After the protocols and protocol configurations are negotiated between the AT and the AN, the AT initiates Point-to-Point Protocol (PPP) and Link Control Protocol (LCP) negotiations for access authentication towards an Authentication, Authorization and Accounting (AAA) server via the AN. The AAA server maintains the subscriber information for authentication, authorization and accounting purposes.

After successful authentication, the AN stores session information, such as supported protocols, authentication keys and Mobile Network ID (MNID) for later use in communications between the AT and the AN during the session. The UATI acts as a pointer to the session records within the AN. Packet data services for the data session are provided through a Packet Data Serving Node (PDSN) that interfaces between the transmission of data in the packet switched data network (e.g., Internet or Intranet), and the transmission of data over the air interface to/from the AT.

However, beyond authenticating a data-only subscriber, there is currently no capability in the 1xEV DO cellular network for providing AT subscribed services. Therefore, it is not possible to provide feature-based services to the subscriber using either a DO AT or a hybrid AT. For example, a DO AT cannot be provided with certain subscribed services, such as multiple PPP sessions, priority delivery from PDSN, etc. In addition, a hybrid AT cannot have certain subscribed features, such as the ability to block incoming voice calls during a data call. Therefore, what is needed is a mechanism for providing an AT profile identifying data services subscribed to by the AT within the data cellular network.

### SUMMARY OF THE INVENTION

The present invention provides an Access Terminal (AT) profile for identifying data services subscribed to by a data-only (DO) AT or hybrid AT in data mode within a data cellular network, such as a 1xEV DO cellular network. In one embodiment, the subscriber AT profile is stored in a home Access, Authentication and Accounting (AAA) server associated with a home Access Network (AN) of the AT. The subscriber AT profile stored in the home AAA server can be downloaded to the home AN at successful authentication. The current session record in the AN is expanded to include the subscriber profile. In another embodiment, when roaming in a visitor AN, the subscriber AT profile can be downloaded from the home AAA server to the visitor AAA server, prior to downloading the subscriber AT profile to the visiting AN. Advantageously, once the subscriber AT profile is stored in the AN, any subscriber profile feature-based service can be controlled by the AN for the lifetime of the AT session.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a block diagram illustrating a 1xEV DO cellular network;

FIG. 2 is a flowchart illustrating the steps for initiating a data session within a 1xEV DO cellular network;

FIG. 3 is a block diagram illustrating an exemplary subscriber AT profile within a data cellular network, in accordance with embodiments of the present invention;

FIG. 4 is a flow diagram illustrating exemplary signaling for downloading the subscriber AT profile from the home AAA server to the home AN, in accordance with embodiments of the present invention;

FIG. 5 is a block diagram illustrating an AT roaming scenario within a subnet of a data cellular network, in accordance with embodiments of the present invention;

FIG. 6 is a flow diagram illustrating exemplary signaling for transferring the subscriber AT profile from the home AN to a visitor AN within the same subnet, in accordance with embodiments of the present invention;

FIG. 7 is a block diagram illustrating an AT roaming scenario within a different subnet of a data cellular network, in accordance with embodiments of the present invention; and

FIG. 8 is a flow diagram illustrating exemplary signaling for downloading the subscriber AT profile from the home AAA server to a visitor AAA server to initiate a data session, in accordance with embodiments of the present invention.

### DETAILED DESCRIPTION OF THE EXEMPLARY EMBODIMENTS

The numerous innovative teachings of the present application will be described with particular reference to the exemplary embodiments. However, it should be understood that these embodiments provide only a few examples of the many advantageous uses of the innovative teachings herein. In general, statements made in the specification of the present application do not necessarily delimit any of the various claimed inventions. Moreover, some statements may apply to some inventive features, but not to others.

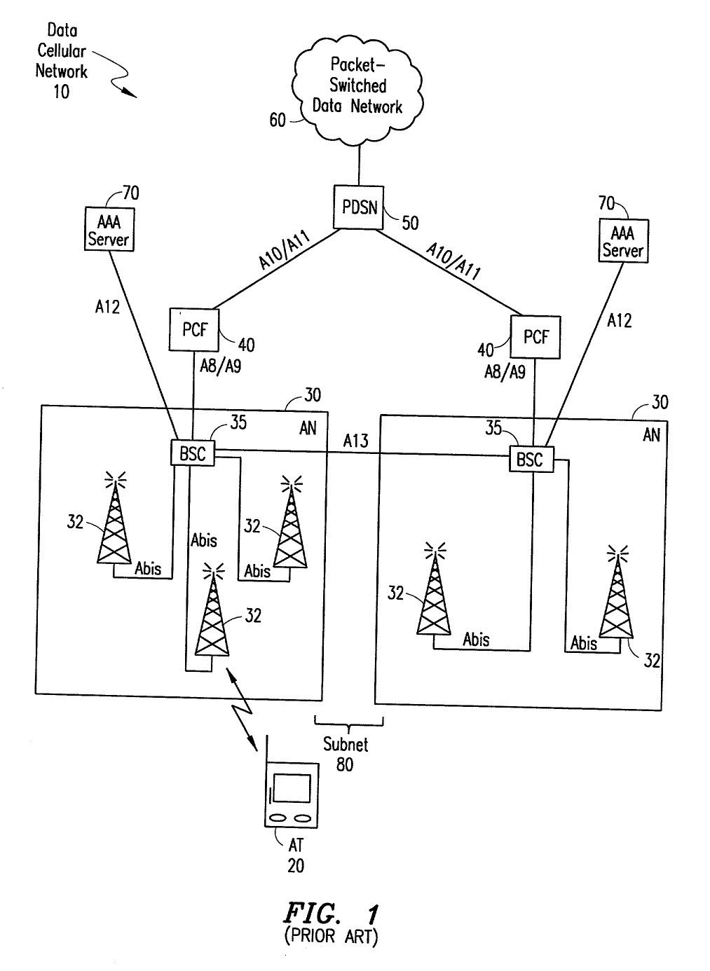

FIG. 1 illustrates the basic architecture of a 1xEV DO cellular network 10. An Access Terminal (AT) 20 is in wireless communication with an Access Network (AN) 30 for data services. The AT 20 is a device providing data connectivity to a user. For example, an AT 20 may be connected to a computing device, such as a laptop personal computer, or the AT 20 may be a self-contained data device, such as a personal digital assistant, the latter being illustrated. The AN 30 is the network equipment that provides data connectivity between a packet switched data network 60 (e.g., the Internet or an Intranet) and the ATs 20.

For example, each AN 30 can include the equivalent of one or more Base Transceiver Stations (BTSs) 32 (e.g., the physical RF interface equipment) and a Base Station Controller (BSC) 35. Each BTS 32 provides a separate 1.25 MHZ data-only (DO) carrier for high data rate applications for each sector (or cell) served by the BTS 32. The BSC 35 is connected to each BTS 32 within the AN 30 via a respective Abis interface. In addition, the BSC 35 is responsible for operation, maintenance and administration of the BTSs 32 and handling the radio resources. It should be understood that the BSC 35 may be a separate node or may be co-located with one or more BTSs 32. All of the BSC's 35 within a Color Code area or subnet 80 (e.g., group of AN's 30) are connected together via respective A13 interfaces. It should be noted that each subnet includes up to 256 neighboring AN's that are allowed to transfer session information between each other.

Packet data services are provided through a Packet Data Serving Node (PDSN) 50 that interfaces between the transmission of data in the packet switched data network 60, and the transmission of data over the air interface to/from the AT 20. The PDSN 50 interfaces with the AN 30 though a Packet Control Function (PCF) 40, which may or may not be co-located with the AN 30. The interface between the AN 30 and the PCF 40 is referred to as the A8/A9 interface, and the interface between the PCF 40 and the PDSN 50 is referred to as the A10/A11 interface. Access authentication of the AT 20 is performed by an Authentication, Authorization and Accounting (AAA) server 70 via an A12 interface between the AN 30 (BSC 35) and the AAA server 70.

In the 1xEV DO network, there are three packet data service states: Active/Connected, Dormant and Null/Inactive. In the Active/Connected state, a physical traffic channel exists between the AT 20 and the AN 30, and either node may send data. In the Dormant state, no physical traffic exists between the AT 20 and the AN 30, but a Point-to-Point Protocol (PPP) link is maintained between the AT 20 and the PDSN 50. In the Null/Inactive state, there is no physical traffic channel between the AT 20 and the AN 30 and no PPP link between the AT 20 and the PDSN 50. The A8 connection is maintained during the Active/Connected state and released during transition to the Dormant or Null/Inactive state, while the A10 connection is maintained during the Active/Connected state and the Dormant state.

As used herein, a data session refers to a shared state between the AT 20 and AN 30. This shared state stores at least the protocols and protocol configurations that are used for communication between the AT 20 and the AN 30 during the data session. The protocols and protocol configurations of the data session are negotiated between the AT 20 and AN 30 during initiation of the data session. A connection refers to a particular state of an air-link (e.g., a physical traffic channel being assigned or not assigned) between the AT 20 and AN 30. During a single data session, the AT 20 and the AN 30 can open and close a connection multiple times.

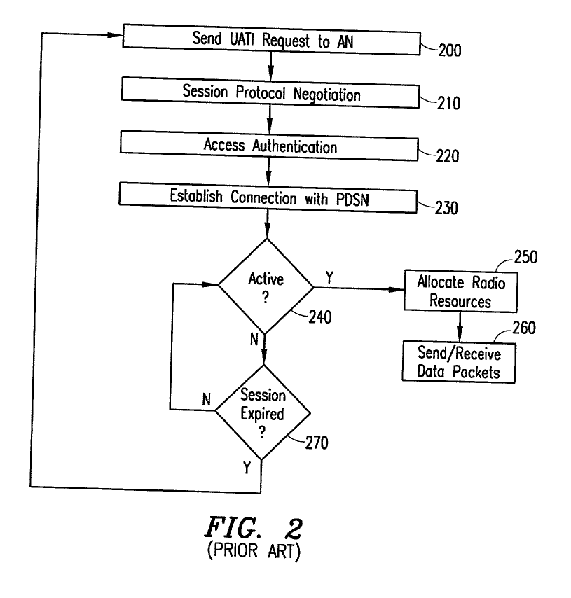

As shown in FIG. 2, to initiate a data session, an AT sends a Unicast Access Terminal Identifier (UATI) request to the AN (step 200). The UATI uniquely identifies the AT within the AN, and further includes an 8-bit field that identifies the Color Code of the AN within a Color Code Area or subnet. Upon receipt of the UATI, the AT engages in a session protocol negotiation process with the serving AN (step 210). The session protocol negotiation process involves the negotiation of protocols and protocol configurations for a session associated with the AT, and the storage of the protocols and protocol configurations within the AT and AN for later use in communications between the AT and the AN during the session. The UATI acts as a pointer to the session records within the AN.

After session configuration, the AT initiates Point-to-Point Protocol (PPP) and Link Control Protocol (LCP) negotiations for access authentication (step 220). The access authentication process involves the AN generating a random challenge and sending the random challenge to the AT in a Challenge Handshake Authentication Protocol (CHAP) Challenge packet. When the AN receives the CHAP response packet from the AT, the AN sends an Access-Request message based on the RADIUS protocol to the AAA server. The AAA server looks up a password based on the user-name attribute in the Access-Request message, and if authentication passes, the AAA server sends an Access-Accept packet containing a RADIUS attribute having the mobile node identification (MN ID) therein to the AN. In response, the AN returns an indication of CHAP authentication success to the AT. The MN ID is used on the A8/A9 and A10/A11 interfaces to permit handoffs of PDSN packet data sessions between AN's.

After authentication, the PCF initiates the setup of an A10 connection with the PDSN (step 230), while the AT is in a Dormant state. After authentication, the AT can transition from the Dormant state to the Active/Connected state at any time during the session (step 240). For example, to transition to the Active/Connected state, the AT can send a connection request message to the AN, which in turn allocates radio resources (e.g., a physical traffic channel) to the AT (step 250) for use in sending/receiving data packets to/from the packet switched data network (step 260). If the AT does not transition to the Active/Connected state, the session remains open for a default duration of 54 hours. However, it should be understood that the session duration can vary depending upon the particular implementation. At the expiration of the original session (step 270), to be able to transmit/receive data packets, the AT must initiate a new data session (step 200) and engage in a new session protocol and authentication negotiation process (steps 210 and 220) for the new data session.

Although the protocols and protocol configurations for each data session may differ between AT's and/or between AN's, the protocols and protocol configurations are dependent upon the type of AT and the protocols supported by the AN, and therefore, not under the control of the mobile subscriber (i.e., the mobile subscriber cannot subscribe to any of the protocols or protocol configurations). Without a centralized database (such as a Home Location Register) for storing subscribed services, data cellular networks have not been able to provide feature-based services to ATs. For example, such feature-based services could include multiple PPP sessions, priority delivery from PDSN and blocking of incoming voice calls during a data call (for hybrid ATs).

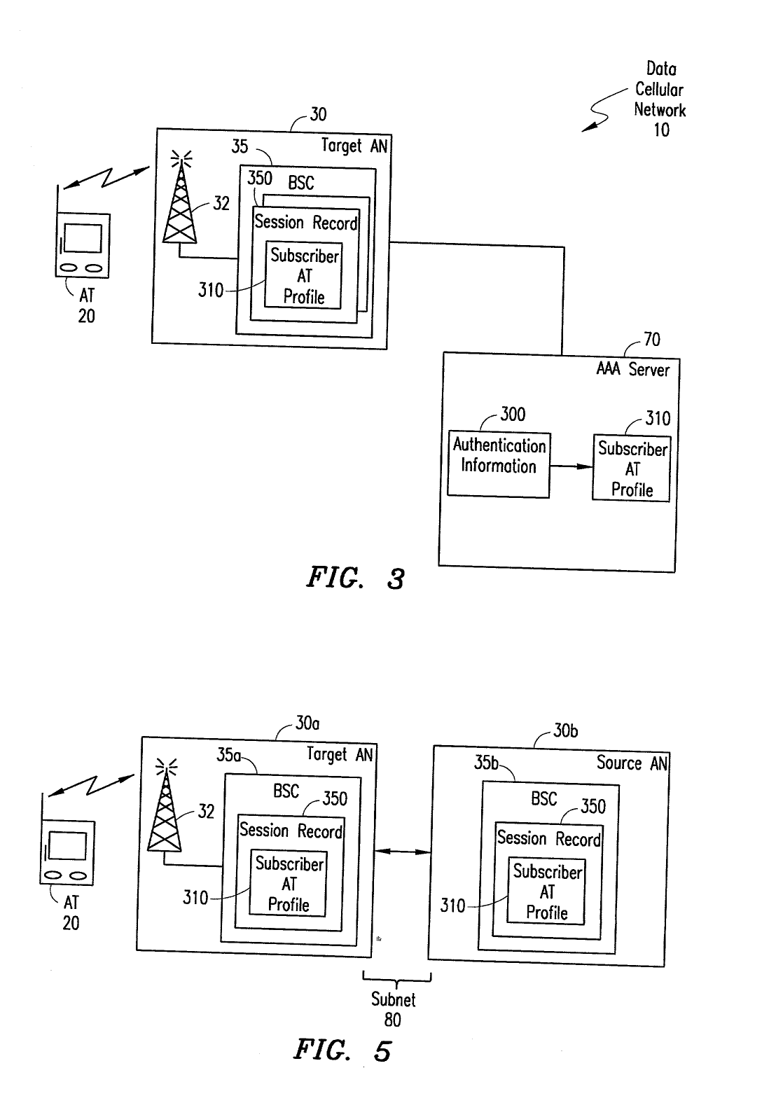

Referring now to FIG. 3, in accordance with embodiments of the present invention, to provide feature-based services subscribed to by a data-only (DO) AT 20 or hybrid AT in data mode within a data cellular network 10, such as a 1xEV DO cellular network, a subscriber AT profile 310 containing subscribed services can be stored in a home Access, Authentication and Accounting (AAA) server 70 associated with a home Access Network (AN) 30 of the AT 20. The home AAA server 70 can maintain a subscriber AT profile 310 for each AT 20 registered with the associated AN 30. Authentication information 300 for each AT 20 points to the respective subscriber AT profile 310. Therefore, upon successful authentication, the subscriber AT profile 310 can be easily located in the AAA server 70.

In addition, the subscriber AT profile 310 stored in the home AAA server 70 can be downloaded to the home AN 30, along with the Access-Accept packet containing the MN ID, at successful authentication. The current session record 350 in the AN 30 (e.g., BSC 35) is also expanded to include the subscriber AT profile 310. Once the subscriber AT profile 310 is stored in the AN 30, any subscriber profile feature services can be controlled by the AN 30 during the data session. For example, if the AT 20 subscribes to a priority delivery service, the AN 30 can prioritize the sending of data packets to the AT 20 based on the priority delivery service features (e.g., packets from a certain IP address to the AT 20 are sent before packets from other IP addresses, packets to the AT 20 are sent before other AT packets, etc.). As another example, if the AT 20 subscribes to a multiple PPP session service, the AN 30 can establish an additional A10 connection (shown in FIG. 1) with the PDSN 50 (shown in FIG. 1) for the AT 20 to enable the AT 20 to download multiple data packets simultaneously (e.g., the AT 20 can access two web sites at the same time). After the data session expires, the AN 30 discards the session record, including the subscriber AT profile 310.

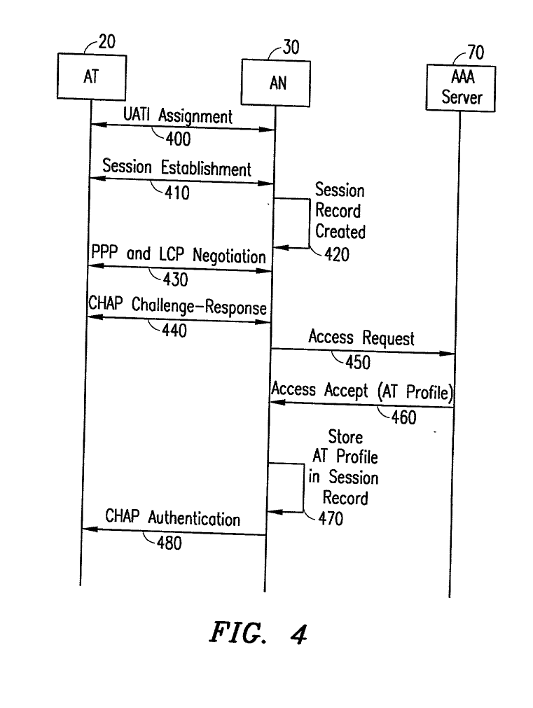

The exemplary signaling involved in downloading the subscriber AT profile to the AN 30 is illustrated in FIG. 4. Once a successful Unicast Access Terminal Identifier (UATI) assignment (step 400) has taken place between the AT 20 and the AN 30, the AT 20 engages in a session protocol negotiation process with the serving AN 30 (step 410), as described above. After session protocol negotiation, the AN 30 creates a session record for the data session and stores the negotiated protocols and protocol configurations therein for later use in communications between the AT 20 and the AN 30 during the session (step 420).

After session configuration, the AT 20 initiates Point-to-Point Protocol (PPP) and Link Control Protocol (LCP) negotiations for access authentication (step 430). During the access authentication process, the AN 30 generates a random challenge and sends the random challenge to the AT 20 in a Challenge Handshake Authentication Protocol (CHAP) Challenge packet to which the AT 20 responds with a CHAP response packet including a user-name attribute (step 440). When the AN 30 receives the CHAP response packet from the AT 20, the AN 30 sends an Access-Request message based on the RADIUS protocol to the AAA server 70 (step 450). The AAA server 70 looks up a password based on the user-name attribute in the Access-Request message to authenticate the AT 20.

If authentication passes and there is a subscriber AT profile associated with the AT 20, the AAA server 70 uses the authentication information stored in the AAA server 70 to locate the subscriber AT profile. In the Access-Accept packet sent to the AN 30 (e.g., BSC), the AAA server 70 includes the subscriber AT profile associated with the mobile node identification (MN ID) of the AT 20 (step 460). In response, the AN 30 stores the subscriber AT profile within the session record for the AT 20 (step 470) and returns an indication of CHAP authentication success to the AT 20 (step 480).

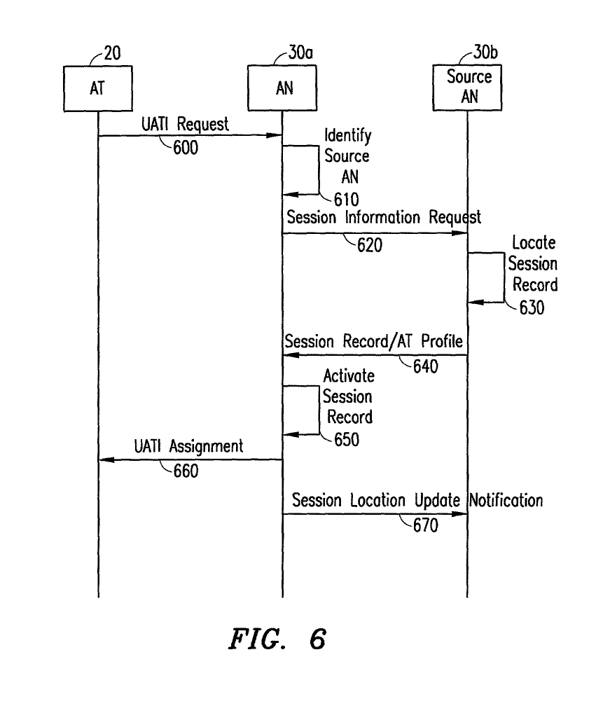

If, as is shown in FIG. 5, the AT 20 roams into a visitor AN 30a within the same subnet 80 as the home AN 30b during the data session, the session record 350, including the subscriber AT profile 310, created for the session in the home AN 30b (i.e., home BSC 35b) can be transferred to the visitor AN 30a (i.e., visitor BSC 35a) without re-negotiation of protocols or re-authentication. For example, as shown in the signaling diagram of FIG. 6, if during the session, the AT 20 roams into an area served by a different AN 30a (step 280), a new UATI request is sent to the new (target) AN 30a (step 600). The new UATI request includes the old UATI assigned to the AT 20 by the original (source) AN 30b. The source AN 30b can be the home AN or another AN.

If the new (target) AN 30a is able to locate the original (source) AN 30b based on the Color Code identity associated with the source AN 30b included in the old UATI (step 610), the session may be able to be transferred from the source AN 30b to the target AN 30a using a session information request message from the target AN 30a to the source AN 30b (step 620). It should be understood that the 8-bit Color Code Identity field within the UATI only provides 256 alternatives, and therefore, the Color Code Identities may be re-used between subnets. Thus, the target AN 30a may only be able to identify the source AN 30b if the source AN 30b is located within the same subnet as the target AN 30a.

Upon receipt of the session information request message (including the old UATI of the source AN 30a), the source AN 30a uses the old UATI to locate the requested session record (step 630) and transfers the identified session record, including the subscriber AT profile, to the target AN 30a via the A13 interface (step 640). The target AN 30a activates the received session record (step 650) and transmits the assigned UATI for the target AN 30a to the AT 20 (step 660). Authentication is not needed once the session record is fetched successfully. Thereafter, the target AN 30a sends a session location update notification to the source AN 30b, causing the session to become inactive (but not closed) in the source AN 30b (step 670).

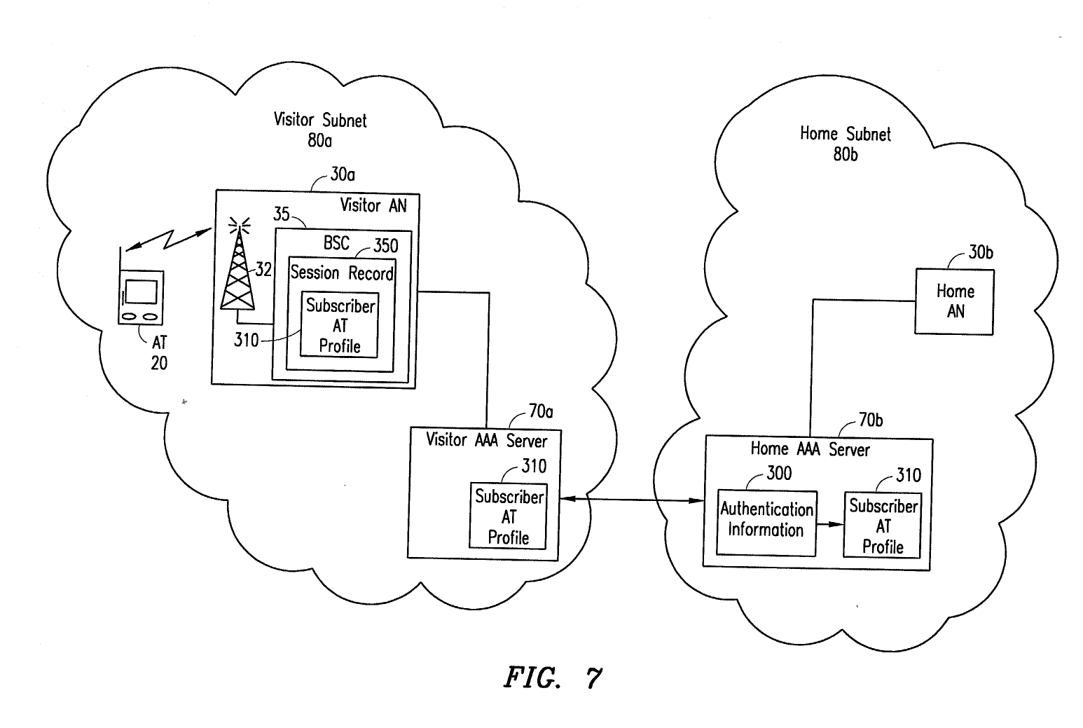

In another embodiment, as shown in FIG. 7, when the AT 20 is roaming in a visitor AN 30a located in a different subnet 80a than the subnet 80b of the original or home AN 30b, or if the AT 20 initiates a data session towards an AN 30a that is not the home AN 30b, the former being illustrated, the subscriber AT profile 310 can be downloaded from the home AAA server 70b to the visitor AAA server 70a once the AT 20 is successfully authenticated in the home AAA server 70b. The visitor AAA server 70a downloads the subscriber AT profile 310 to the visitor AN 30a (i.e., visitor BSC 35) for storage in the session record 350 created for the data session. The visitor BSC 35 uses the subscriber AT profile 310 during the data session to provide subscribed services to the AT 20.

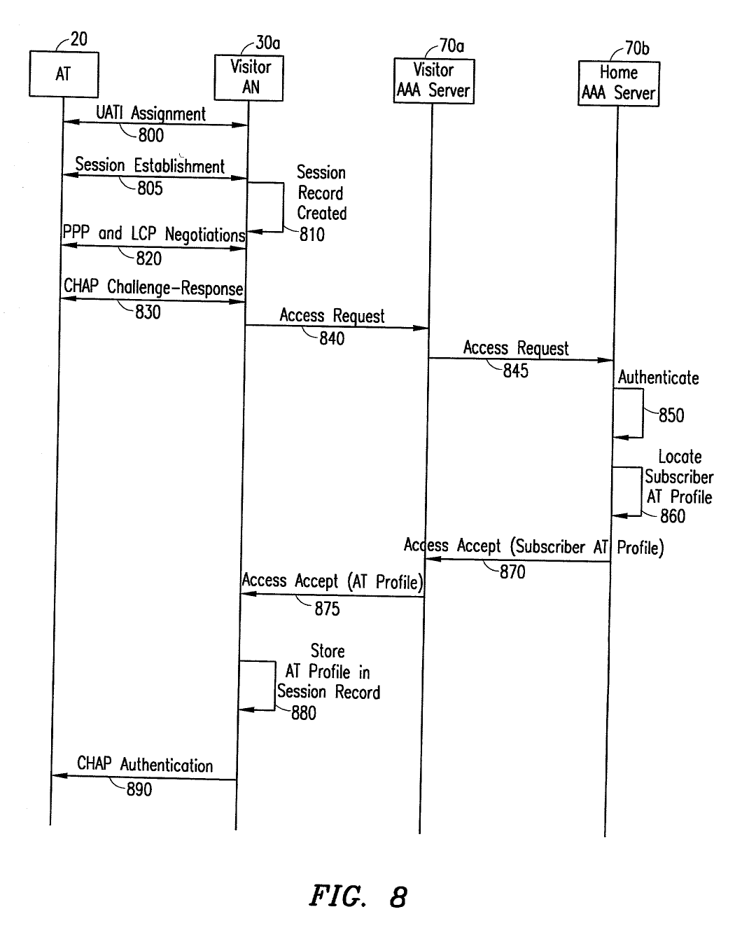

For example, as shown in FIG. 8, if the AT 20 initiates a data session towards an AN 30a that is not the home AN 30b, after UATI assignment (step 800), session protocol negotiation (step 804) and the creation of a session record for the data session (step 810), the AT 20 engages in Point-to-Point Protocol (PPP) and Link Control Protocol (LCP) negotiations for access authentication (step 820) with the visitor AN 30a. During the access authentication process, the visitor AN 30a generates a random challenge and sends the random challenge to the AT 20 in a Challenge Handshake Authentication Protocol (CHAP) Challenge packet to which the AT 20 responds with a CHAP response packet including a user-name attribute (step 830). When the visitor AN 30a receives the CHAP response packet from the AT 20, the visitor AN 30a sends an Access-Request message, including the user-name attribute to the visitor AAA server 70a (step 840).

Since the AT 20 is not registered in the visitor AAA server 70a, the visitor AAA server 70a uses the user-name attribute to determine the home AAA server 70b, and forwards the Access-Request message to the home AAA server 70b (step 845). The home AAA server 70b looks up a password based on the user-name attribute in the Access-Request message to authenticate the AT 20 (step 850). If authentication passes and there is a subscriber AT profile associated with the AT 20, the home AAA server 70b uses the authentication information stored in the home AAA server 70b to locate the subscriber AT profile (step 860), and downloads the subscriber AT profile, along with other information, such as the MN ID, in an Access-Accept As packet to the visitor AAA server 70a (step 870). In the Access-Accept packet sent to the visitor AN 30a (e.g., BSC), the visitor AAA server 70a includes the subscriber AT profile associated with the MN ID of the AT 20 (step 875). In response, the visitor AN 30a stores the subscriber AT profile within the session record for the AT 20 (step 880) and returns an indication of CHAP authentication success to the AT 20 (step 890).

As another example, and as is shown in FIG. 7, if the AT 20 roams into an area served by a new (target) AN 30a located within a different subnet 80a than the original (source) AN 30b for the data session, the target AN 30a may not be able to locate the source AN 30b, and the session must be re-negotiated over the air interface as if the original session never existed. For example, if an AT 20 roams to a target AN 30a that is not within the same subnet 80a as the subnet 80b of the source AN 30b, any attempted dormant handoff will fail since the correct source AN 30b cannot be verified (i.e., the Color Code included in the previously assigned UATI is not recognized in the new subnet 80a). Therefore, upon entering a new subnet 80a, the AT 20 must re-negotiate an entirely new session, as described above in connection with FIG. 8.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

What is claimed is:

1. A data cellular network having a plurality of access networks, each of the plurality of access networks being capable of being in wireless communication with a plurality of access terminals to provide data connectivity between a packet switched data network and the plurality of access terminals during respective data sessions associated with the plurality of access terminals, said data cellular network comprising:
a server associated with only a select one of the plurality of access networks for authenticating the plurality of access terminals involved in respective data sessions via the select s access network, said sever being configured to maintain at least one subscriber profile identifying data services subscribed to by at least one of the plurality of access terminals registered with the select access network, said server further being configured to download said at least one subscriber profile to the select access network upon authentication of the associated at least one access terminal for use by the select access network during respective data sessions associated with the at least one access terminal.

2. The data cellular network of claim 1, wherein said server is further configured to maintain authentication information for the at least one access terminal, said authentication information being used to determine said at least one subscriber profile associated with the at least one access terminal.

3. The data cellular network of claim 1, wherein the data cellular network is a 1xEV DO cellular network, and wherein said server is further configured to download said at least one subscriber profile to the select access network in an Access-Accept packet.

4. The data cellular network of claim 1, wherein the select access network includes a session record for a data session associated with a select one of the plurality of access terminals, said subscriber profile associated with the select access terminal being stored within said session record.

5. The data cellular network of claim 4, wherein the select access network discards said session record upon termination of said data session associated with the select access terminal.

6. The data cellular network of claim 4, wherein the select access network downloads said session record including said subscriber profile from an additional one of the plurality of access networks during said data session.

7. The data cellular network of claim 4 wherein said server is further configured to receive said subscriber profile associated with the select access terminal from an additional server associated with an additional one of the plurality of access networks having the select access terminal registered therewith and download said subscriber profile associated with the select access terminal to the select access network.

8. The data cellular network of claim 7, wherein said server associated with the select access network is located within a first subnet of access networks and associated servers and said additional server associated with said additional access network is located within a second subnet of access networks and associated servers.

9. In a data cellular network having a plurality of access networks, each of the plurality of access networks being capable of being in wireless communication with a plurality of access terminals to provide data connectivity between a packet switched data network and the plurality of access terminals during respective data sessions associated with the plurality of access terminals, a select one of the plurality of access networks comprising:
a session record for a select one of the plurality of access terminals registered with the select access network and involved in a data session via the select access network;
means for downloading a subscriber profile identifying data services subscribed to by the select access terminal from a server associated with only the select access network; and
means for storing said subscriber profile within said session record for use during said data session.

10. The access network of claim 9, wherein the data cellular network is a 1xEV DO cellular network, and wherein said means for downloading comprises means for receiving an Access-Accept packet from said server containing said subscriber profile.

11. The access network of claim 9, further comprising:
means for discarding said session record upon termination of said data session associated with the select access terminal.

12. The access network of claim 9, further comprising:
an additional session record for an additional one of the plurality of access terminals involved in an additional data session via the select access network;
means for downloading an additional subscriber profile identifying data services subscribed to by the additional access terminal from an additional one of the plurality of access networks having said additional data session previously associated therewith; and
means for storing said subscriber profile within said additional session record for use during said additional data session.

13. The access network of claim 9, further comprising:
an additional session record for an additional one of the plurality of access terminals registered with an additional one of the plurality of access networks and involved in an additional data session via the select access network;
means for downloading an additional subscriber profile identifying data services subscribed to by the additional access terminal from an additional server associated with only said additional access network via said server; and
means for storing said subscriber profile within said additional session record for use during said additional data session.

14. The access network of claim 13, wherein said select access network is located within a first subnet of access networks and associated servers and said additional access network is located within a second subnet of access networks and associated servers.

15. A method for providing data services subscribed to by mobile subscribers within a data cellular network having a plurality of access networks, each of the plurality of access networks being capable of being in wireless communication with a plurality of access terminals to provide data connectivity between a packet switched data network and the plurality of access terminals during respective data sessions associated with the plurality of access terminals, said method comprising the steps of:
maintaining at least one subscriber profile identifying data services subscribed to by at least one of the plurality of access terminals registered with the select access network within a server associated with only a select one of the plurality of access networks, said server further for authenticating the plurality of access terminals involved in respective data sessions via the select access network; and
downloading said at least one subscriber profile to the select access network upon authentication of the associated at least one access terminal for use by the select access network during respective data sessions associated with the at least one access terminal.

16. The method of claim 15, further comprising the step of:
determining said at least one subscriber profile associated with the at least one access terminal using authentication information for the at least one access terminal.

17. The method of claim 15, wherein the data cellular network is a 1xEV DO cellular network, and wherein said step of downloading further comprises the step of:
downloading said at least one subscriber profile to the select access network in an Access-Accept packet.

18. The method of claim 15, further comprising the step of:
storing said downloaded subscriber profile associated with a select one of the plurality of access terminals within a session record for a data session associated with the select access terminal within the select access network.

19. The method of claim 18, further comprising the step of:
discarding said session record from the select access network upon termination of said data session associated with the select access terminal.

20. A method for providing data services subscribed to by mobile subscribers within a data cellular network having a plurality of access networks, each of the plurality of access networks being capable of being in wireless communication with a plurality of access terminals to provide data connectivity between a packet switched data network and the plurality of access terminals during respective data sessions associated with the plurality of access terminals, said method comprising the steps of:
storing a session record for a select one of the plurality of access terminals registered with a select one of the plurality of access networks and involved in a data session via the select access network within the select access network;
downloading a subscriber profile identifying data services subscribed to by the select access terminal from a server associated with only the select access network; and
storing said subscriber profile within said session record for use during said data session.

21. The method of claim 20, wherein the data cellular network is a 1xEV DO cellular network, and wherein said step of downloading further comprises the step of receiving an Access-Accept packet from said server containing said subscriber profile.

22. The method of claim 20, further comprising the step of:
discarding said session record upon termination of said data session associated with the select access terminal.

23. The method of claim 20, further comprising the steps of:
storing an additional session record for an additional one of the plurality of access terminals involved in an additional data session via the select access network within the select access network;
downloading an additional subscriber profile identifying data services subscribed to by the additional access terminal from an additional one of the plurality of access networks having said additional data session previously associated therewith; and
storing said subscriber profile within said additional session record for use during said additional data session.

24. The method of claim 20, further comprising the steps of:
storing an additional session record for an additional one of the plurality of access terminals registered with an additional one of the plurality of access networks and involved in an additional data session via the select access network within the select access network;
downloading an additional subscriber profile identifying data services subscribed to by the additional access terminal from an additional server associated with only said additional access network via said server; and
storing said subscriber profile within said additional session record for use during said additional data session.
